(19) United States
(12) Patent Application Publication
(10) Pub. No.: US 2016/0379122 A1
(43) Pub. Date: Dec. 29, 2016

(54) RECOMMENDATION ALGORITHM OPTIMIZATION METHOD, DEVICE AND SYSTEM

(71) Applicant: TENCENT TECHNOLOGY (SHENZHEN) COMPANY LIMITED, Shenzhen City, Guangdong (CN)

(72) Inventor: Zhangmin CHENG, Shenzhen (CN)

(73) Assignee: TENCENT TECHNOLOGY (SHENZHEN) COMPANY LIMITED, Shenzhen, Guangdong (CN)

(21) Appl. No.: 15/102,175

(22) PCT Filed: Feb. 11, 2015
(86) PCT No.: PCT/CN2015/072713

§ 371 Date: Jun. 6, 2016

(30) Foreign Application Priority Data
Dec. 13, 2013 (CN) 201310689281.1

(51) Int. Cl. G06N 5/02; G06N 7/00

(52) U.S. Cl. CPC G06N 5/022; G06N 7/005

(57) ABSTRACT

Obtaining statistical effectiveness data of each recommendation algorithm; obtaining traffic distribution probability of each recommendation algorithm according to weight of the effectiveness data of each recommendation algorithm in recommendation algorithms; and distributing traffic request for each recommendation algorithm according to the traffic distribution probability.

### CROSS REFERENCE OF RELATED APPLICATION

The present disclosure claims the benefit of Chinese application No. 201310689281.1, filed on Dec. 13, 2013, entitled “RECOMMENDATION ALGORITHM OPTIMIZATION METHOD, DEVICE AND SYSTEM”, which is incorporated herein by reference in its entirety.

### TECHNICAL FIELD

The present disclosure relates to computer technologies, and more particularly, to a recommendation algorithm optimization method, device and system.

### BACKGROUND OF THE INVENTION

Generally, multiple recommendation algorithms are simultaneously running in a recommendation engine of a recommendation system. Effectiveness data of each recommendation algorithm is counted when offline. Then, traffic distribution of each recommendation algorithm is adjusted based on off-line statistical results, thereby further optimizing the overall recommendation effect.

One traditional recommendation algorithm optimization process includes: determining a new recommendation algorithm and a small amount of traffic corresponding to the new recommendation algorithm; after a recommendation engine is ready, allocating, by an administrator, traffic for the new recommendation algorithm at the front end; observing recommendation effect of the new recommendation algorithm; if the recommendation effect is good, the administrator continues to allocate traffic for the new recommendation algorithm; repeating the above blocks until all the traffic is allocated to the recommendation algorithm with the best recommendation effect.

### SUMMARY OF THE INVENTION

In order to solve problems of manually allocating traffic for recommendation algorithms and long optimization period during the process of optimization in the prior art, embodiments of the present disclosure provide a recommendation algorithm optimization method, device and system. The technical solutions are as follows.

In a first aspect, a recommendation algorithm optimization method is provided and includes:

obtaining statistical effectiveness data of each recommendation algorithm, wherein the effectiveness data is to reflect a recommendation success rate of each recommendation algorithm within an identical statistical time window;

obtaining a traffic distribution probability of each recommendation algorithm, according to weight of the effectiveness data of each recommendation algorithm in the effectiveness data of recommendation algorithms; and,

distributing traffic requests for each recommendation algorithm according to the traffic distribution probability.

In a second aspect, a recommendation algorithm optimization device is provided and includes an obtaining module, a calculation module and a distribution module, in which

the obtaining module obtains statistical effectiveness data of each recommendation algorithm, wherein the effectiveness data is to reflect a recommendation success rate of each recommendation algorithm within an identical statistical time window;

the calculation module obtains a traffic distribution probability of each recommendation algorithm, according to weight of the effectiveness data of each recommendation algorithm obtained by the obtaining module in the effectiveness data of recommendation algorithms; and

the distribution module distributes traffic requests for each recommendation algorithm, according to the traffic distribution probability obtained by the calculation module through calculating.

In a third aspect, a recommendation algorithm optimization device is provided and includes a processor, a memory and a non-transitory storage. The non-transitory storage stores computer programs for implementing recommendation algorithm optimization;

the processor loads the computer programs from the non-transitory storage into the memory, and runs the computer programs to form computer-executable instructions, and the computer-executable instructions are stored in an obtaining module, a calculation module and a distribution module;

the obtaining module obtains statistical effectiveness data of each recommendation algorithm, and the effectiveness data is to reflect a recommendation success rate of each recommendation algorithm within an identical statistical time window;

the calculation module obtains a traffic distribution probability of each recommendation algorithm, according to weight of the effectiveness data of each recommendation algorithm obtained by the obtaining module in the effectiveness data of recommendation algorithms; and

the distribution module distributes traffic requests for each recommendation algorithm according to the traffic distribution probability obtained by the calculation module through calculating.

In a fourth aspect, a recommendation algorithm optimization system is provided and includes a server and at least one terminal. The server includes the recommendation algorithm optimization device of the second aspect or the third aspect.

The beneficial effects achieved by the technical solutions of the embodiments of the present disclosure are as follows.

The problems of manually allocating traffic for recommendation algorithms and long optimization period during the process of optimization in the prior art are solved by obtaining statistical effectiveness data of each recommendation algorithm, calculating traffic distribution probability of each recommendation algorithm according to the effectiveness data of each recommendation algorithm, and distributing traffic request for each recommendation algorithm according to the traffic distribution probability of each recommendation algorithm. Herein, the effectiveness data of the recommendation algorithm reflects a recommendation success rate of the recommendation algorithm. Since traffic may be automatically allocated to each recommendation algorithm according to the statistical recommendation success rate of each recommendation algorithm, thus more traffic may be allocated to recommendation algorithms with high recommendation success rates in a better manner, thereby greatly shortening the optimization period and improving efficiency and accuracy of optimization.

### BRIEF DESCRIPTION OF THE DRAWINGS

FIG. 1 is a schematic diagram of an implementation environment involved in a recommendation algorithm optimization method according to one example of the present disclosure;

FIG. 2 is a flow chart of a recommendation algorithm optimization method according to one example of the present disclosure;

FIG. 3A is a flow chart of a recommendation algorithm optimization method according to another example of the present disclosure;

FIG. 3B is a statistical schematic diagram of counting a recommendation success rate corresponding to each of selected time periods according to some examples of the present disclosure;

FIG. 4 is a schematic diagram of internal structures of a server involved in some examples of the present disclosure;

FIG. 5 is a flow chart illustrating a process of distributing recommendation algorithms for traffic requests according to one example of the present disclosure;

FIG. 6 is a schematic diagram illustrating structure of a recommendation algorithm optimization device according to one example of the present disclosure;

FIG. 7 is a schematic diagram illustrating structure of a recommendation algorithm optimization device according to another example of the present disclosure;

FIG. 8 is a schematic diagram illustrating structure of a server according to some examples of the present disclosure;

FIG. 9 is a schematic diagram of a recommendation algorithm optimization system according to one example of the present disclosure;

FIG. 10 is a schematic diagram illustrating structure of a recommendation algorithm optimization device according to another example of the present disclosure.

### EMBODIMENTS OF THE INVENTION

In order to make objectives, technical solutions and advantages of the present disclosure more clear, examples of the present disclosure will be described hereinafter accompanying with attached drawings. Hereinafter, the term “at least one” refers to one, two or more.

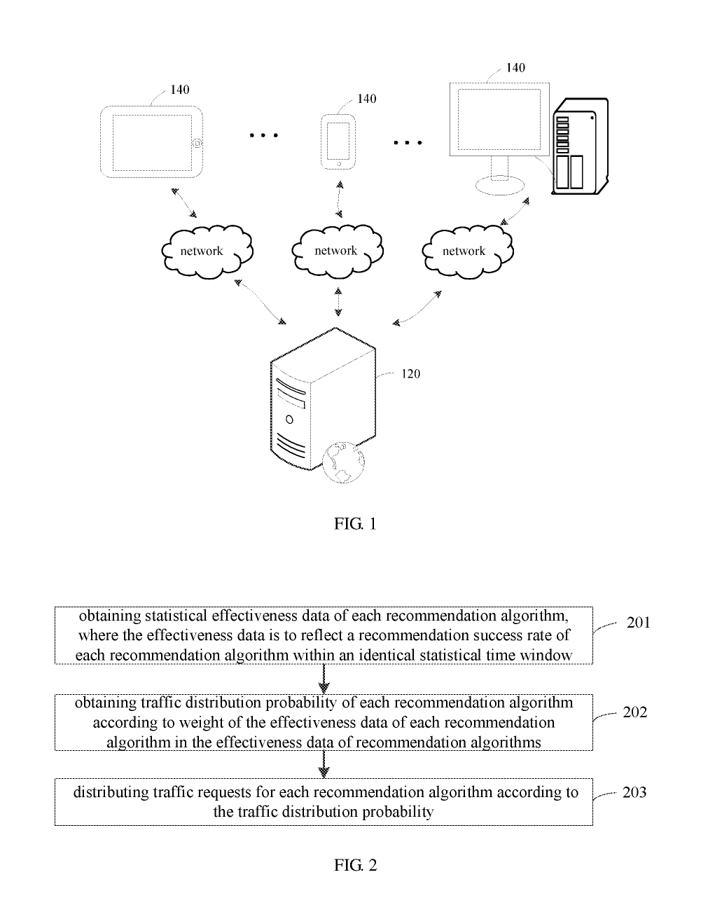

Referring to FIG. 1, FIG. 1 is a schematic diagram of an implementation environment involved in a recommendation algorithm optimization method, according to one example of the present disclosure. The implementation environment may include a server 120 and at least one terminal 140. The server 120 may be connected to the terminal 140 through a wire network or a wireless network.

The server 120 has a function of recommending services to the terminal 140, for example, recommending corresponding services to a user of the terminal, according to information such as content browsed and searched by the user in a browser as well as operation of the user. The server 120 may be one server, a server cluster composed of a plurality of servers, or a cloud computing service center. The server 140 may be a background server of a recommendation system.

The terminal 140 may respond to recommendation services sent by the server 120, for example, clicking to browse the recommendation services. The terminal 140 generally may be a smart phone, a tablet computer, a smart TV, an e-book reader, a Moving Picture Experts Group Audio Layer III (MP3) player, a Moving Picture Experts Group Audio Layer IV (MP4) player, a portable laptop computer, or a desktop computer.

Referring to FIG. 2, FIG. 2 is a flow chart of a recommendation algorithm optimization method according to one example of the present disclosure. Descriptions are provided with an example, where the recommendation algorithm optimization method is applied in the server 120 of the implementation environment shown in FIG. 1. The recommendation algorithm optimization method may include the following blocks.

In block 201, obtain statistical effectiveness data of each recommendation algorithm, and the effectiveness data is to reflect a recommendation success rate of each recommendation algorithm within an identical statistical time window.

In block 202, obtain traffic distribution probability of each recommendation algorithm, according to weight of the effectiveness data of each recommendation algorithm in the effectiveness data of recommendation algorithms.

In block 203, distribute traffic requests for each recommendation algorithm according to the traffic distribution probability.

In sum, the recommendation algorithm optimization method according to one example of the present disclosure solves the problems of manually allocating traffic for recommendation algorithms and long optimization period during the process of optimization in the prior art, by obtaining statistical effectiveness data of each recommendation algorithm, calculating traffic distribution probability of each recommendation algorithm according to the effectiveness data of each recommendation algorithm, and distributing traffic request for each recommendation algorithm according to the traffic distribution probability. Herein, the effectiveness data of the recommendation algorithm reflects a recommendation success rate of the recommendation algorithm. Since traffic may be automatically allocated to each recommendation algorithm according to the statistical recommendation success rate of each recommendation algorithm, thus more traffic may be allocated to recommendation algorithms with high recommendation success rates in a better manner, thereby greatly shortening the optimization period and improving efficiency and accuracy of optimization.

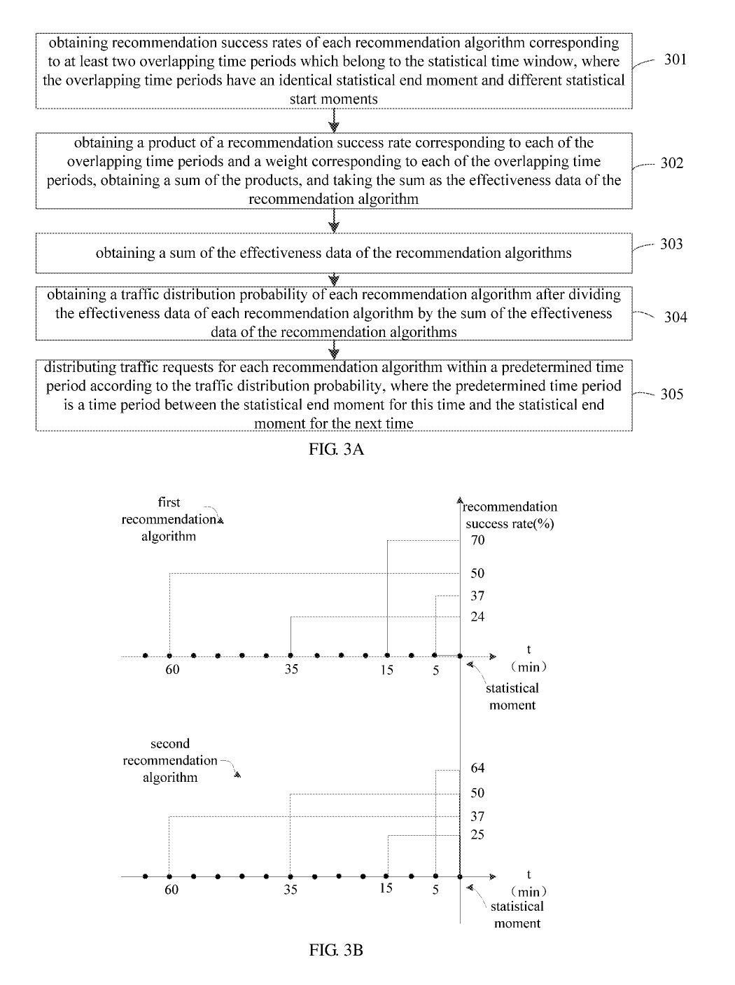

Referring to FIG. 3A, FIG. 3A is a flow chart of a recommendation algorithm optimization method, according to one example of the present disclosure. Descriptions will be provided with an example, where the recommendation algorithm optimization method is applied in the server 120 of the implementation environment shown in FIG. 1. The recommendation algorithm optimization method may include the following blocks.

In block 301, obtain recommendation success rates of each recommendation algorithm corresponding to at least two overlapping time periods which belong to the statistical time window. The overlapping time periods have an identical statistical end moment and different statistical start moments.

Herein, the recommendation algorithm may provide recommendation services for the terminal. When implemented, one server for providing recommendation services generally includes a plurality of recommendation algorithms. When one terminal sends a traffic request to the server, the server may select one recommendation algorithm for the traffic request, determine a recommendation result for the traffic request according to the selected recommendation algorithm, and send the recommendation result to the terminal. In this way, the terminal may respond according to the recommendation result, for example, clicking to browse the recommendation result (i.e., successful response to the recommendation result). Of course, the terminal may also ignore the recommendation result, i.e., no response to the recommendation result or no successful response.

The server may distribute traffic requests for recommendation algorithms based on the recommendation success rates of the recommendation algorithms. Apparently, when obtaining the recommendation success rates of the recommendation algorithms, it is needed to determine the recommendation success rates of the recommendation algorithms according to collected responses given by the terminal to the recommendation results recommended by the recommendation algorithms.

When implemented, the recommendation success rates of the recommendation algorithms may be affected by a plurality of factors, and are usually not stable in a short time period. For example, a recommendation algorithm may have a low recommendation success rate at every day before one day, but have a greatly increased recommendation success rate at the one day (for example, when online price is relatively low due to holiday promotions, the recommendation success rate of the recommendation algorithm may be relatively high). The recommendation success rate at the one day cannot accurately represent the recommendation success rate of the recommendation algorithm. Thus, in specific statistical process, multiple different time periods are usually selected to optimize the recommendation algorithm. The time periods have an identical statistical end moment and different statistical start moments. Herein, the identical statistical end moment is an end moment of the statistical time window, and the statistical end moment may be the same as a statistical moment of this statistics or may be different from the statistical moment of this statistics, i.e., one moment before the statistical moment of this statistics.

For example, when performing statistics at an identical statistical moment for some time periods corresponding to a recommendation algorithm, a plurality of different time periods before this statistical moment may be selected for performing statistics. For example, a recommendation success rate of the recommendation algorithm within five minutes before the statistical moment may be counted, and a recommendation success rate of the recommendation algorithm within one hour before the statistical moment may be counted. Herein, the end moment of the statistical time window may be the same as the statistical moment. For example, when the statistical moment is nine o'clock in the morning on Sep. 10, 2012, the selected time periods may include a period within five minutes before the nine o'clock in the morning on Sep. 10, 2012, a period within one hour before the nine o'clock in the morning on Sep. 10, 2012, and a period within one day, one week or one month before the nine o'clock in the morning on Sep. 10, 2012, and a recommendation success rate of each recommendation algorithm within each of these time periods is counted.

Referring to FIG. 3B, FIG. 3B is a statistical schematic diagram of counting a recommendation success rate corresponding to each of selected time periods according to some examples of the present disclosure. FIG. 3B shows a recommendation success rate of a first recommendation algorithm corresponding to each of selected time periods, and a recommendation success rate of a second recommendation algorithm corresponding to each of the selected time periods. The selected time periods are respectively as follows: a period within five minutes before the statistical moment (a first time period); a period within fifteen minutes before the statistical moment (a second time period); a period within thirty-five minutes before the statistical moment (a third time period); and a period within sixty minutes before the statistical moment (a fourth time period). For the first recommendation algorithm, the first recommendation algorithm has a recommendation success rate of 37% within the first time period, a recommendation success rate of 70% within the second time period, a recommendation success rate of 24% within the third time period, and a recommendation success rate of 50% within the fourth time period. For the second recommendation algorithm, the second recommendation algorithm has a recommendation success rate of 64% within the first time period, a recommendation success rate of 25% within the second time period, a recommendation success rate of 50% within the third time period, and a recommendation success rate of 37% within the fourth time period.

For another example, when performing statistics at an identical statistical moment for some time periods corresponding to a recommendation algorithm, a plurality of different time periods before one specified moment may be selected for performing statistics. Herein, the specified moment is the end moment of the statistical time window, and the end moment of the statistical time window is one moment before the statistical moment of this statistics. For example, when the statistical moment is nine o'clock in the morning on Sep. 10, 2012, the specified moment may be seven o'clock in the morning on Sep. 9, 2012, and then the selected time periods may include a period within five minutes before seven o'clock in the morning on Sep. 9, 2012, a period within one hour before seven o'clock in the morning on Sep. 9, 2012, and a period within one day or one week before seven o'clock in the morning on Sep. 9, 2012, and a recommendation success rate of each recommendation algorithm within each of these time periods is counted.

In one possible implementation, one process of obtaining a recommendation success rate of a recommendation algorithm within each time period includes following blocks.

First, a corresponding response action and a recommendation result of the recommendation algorithm within each time period is obtained. The response action is a successful response from at least one terminal within each time period to the recommendation result determined according to the recommendation algorithm, and the recommendation result is determined according to the recommendation algorithm within each time period.

When implemented, the terminals continuously send traffic requests to the server. After the server receives the traffic requests, the server distributes recommendation algorithms for the traffic requests. After the server distributes a recommendation algorithm for a traffic request, the server usually marks the traffic request with a tag, and the tag is to indicate that the traffic request is processed by the marked recommendation algorithm; correspondingly, the recommendation algorithm processes the traffic request, determines the recommendation result for the traffic request and sends the recommendation result to the terminal which sends the traffic request. In this way, the terminal may make a positive response operation, such as clicking to browse. Apparently, if the user of the terminal has no interest in the recommendation result, the user usually ignores the recommendation result, such as making no response to the recommendation result or directly closing the recommendation result. Herein, the response action is the positive response operation from the terminal in response to the recommendation result, or is a successful response from the terminal in response to the recommendation result.

Since one moment when the recommendation result is sent to the terminal and one moment when the terminal makes a response action can be determined, thus, a corresponding response action and a recommendation result of one recommendation algorithm within a given time period can be obtained.

Second, the number of the response actions and the number of the recommendation results are counted.

For a time period, the server can count a total number of the response actions and a total number of the recommendation results corresponding to each recommendation algorithm within the time period.

Third, a quotient value obtained by dividing the number of the response actions by the number of the recommendation results is determined as a recommendation success rate of the recommendation algorithm within the time period.

For a time period, a quotient value is obtained after dividing the number of the response actions counted for a recommendation algorithm by the number of the recommendation results counted for the recommendation algorithm, and this quotient value is taken as a recommendation success rate of the recommendation algorithm within the time period. It should be noted, when implemented, since the terminal does not respond to all recommendation results, thus, the quotient value is usually less than 1.

It is noted that, for different recommendation algorithms, the selected time periods shall be the same. For example, for the first recommendation algorithm, the selected time periods include a period within one hour before the statistical moment and a period within seven days before the statistical moment; accordingly, for the second recommendation algorithm, the selected time periods also include a period within one hour before the statistical moment and a time period within seven days before the statistical moment.

In block 302, obtain a product of a recommendation success rate corresponding to each of the overlapping time periods and a weight corresponding to each of the overlapping time periods, and obtain a sum of the products and take the sum as the effectiveness data of the recommendation algorithm within the statistical time window.

Generally, since different time periods may have different impacts on the recommendation success rates, when determining a total recommendation success rate of a recommendation algorithm, it usually needs to set weights for different time periods in advance according to actual situations. For example, a first time period within seven days before the statistical moment and a second time period within five minutes before the statistical moment usually have different impacts on the recommendation success rates. Generally, the first time period is of a longer time span, and the recommendation success rate within the first time period may estimate subsequent recommendation effect of the recommendation algorithm in a better manner, i.e., having a large impact on the recommendation algorithm. The second time period is of a shorter time span, and the recommendation success rate determined within the second time period of a shorter time span may have poor stability due to network conditions and other unforeseen circumstances. Thus, when considering recommendation effect, less consideration is usually given to the impact of the second time period.

For a recommendation algorithm, the recommendation success rates of the recommendation algorithm in a plurality of time periods have been determined in the block 301, and then the effectiveness data of the recommendation algorithm may be determined according to the recommendation success rate and the weight corresponding to each time period. The specific algorithm includes: obtaining a product of a recommendation success rate of the recommendation algorithm corresponding to each time period and a corresponding weight, that is, obtaining the product corresponding to each time period, and obtaining a sum of the products and taking the sum as the effectiveness data of the recommendation algorithm. For example, when the time periods selected for the recommendation algorithm are one hour before the statistical moment, three hours before the statistical moment, five hours before the statistical moment, one day before the statistical moment, seven days before the statistical moment, respectively; the counted recommendation success rates corresponding to the foregoing time periods are w_1hour, w_3hour, w_5hour, w_1day and w_7day, respectively; weights corresponding to the foregoing time periods are Effect_1hour, Effect_3hour, Effect_5hour, Effect_1day and Effect_7day, respectively; then, the finally obtained effectiveness data of the recommendation algorithm is: Effect_final=w_1hour*Effect_1hour +w_3hour*Effect_3hour+w_5hour*Effect_5hour+w_1day*Effect_1day+w_7day* Effect_7day.

Still referring to FIG. 3B, if the weights set for the first time period, the second time period, the third time period and the fourth time period are 0.1, 0.2, 0.3 and 0.4, respectively, the effectiveness data of the first recommendation algorithm is 44.9%=0.1*37%+0.2*70%+0.3*24%+0.4*50%. Similarly, the effectiveness data of the second recommendation algorithm is 41.2%=0.1*64%+0.2*25%+0.3*50%+0.4*37%.

In block 303, obtain a sum of the effectiveness data of each recommendation algorithm.

In block 304, obtain a traffic distribution probability of each recommendation algorithm, after dividing the effectiveness data of each recommendation algorithm by the sum of the effectiveness data of each recommendation algorithm.

For example, for three recommendation algorithms including a first recommendation algorithm, a second recommendation algorithm and a third recommendation algorithm, the effectiveness data of each recommendation algorithm is respectively first effectiveness data, second effectiveness data and third effectiveness data, then, the traffic distribution probability of the first recommendation algorithm is equal to: first effectiveness data/(first effectiveness data+second effectiveness data+third effectiveness data). Correspondingly, the traffic distribution probability of the second recommendation algorithm is equal to: second effectiveness data/(first effectiveness data+second effectiveness data+third effectiveness data); the traffic distribution probability of the third recommendation algorithm is equal to: third effectiveness data/(first effectiveness data+second effectiveness data+third effectiveness data).

Still referring to FIG. 3B, supposing that there are only a first recommendation algorithm and a second recommendation algorithm, then the traffic distribution probability of the first recommendation algorithm is 44.9%/(44.9%+41.2%)=52.15%; the traffic distribution probability of the second recommendation algorithm is 41.2%/(44.9%+41.2%)=47.85%.

In block 305, distribute traffic requests for each recommendation algorithm within a predetermined time period according to the traffic distribution probability. The predetermined time period is a time period between the statistical end moment for this time and the statistical end moment for the next time.

When implemented, since the server may receive traffic requests sent from a large amount of terminals, the server needs to continuously count the latest traffic distribution probability, so as to improve recommendation effect for the traffic requests in a better manner. The server may receive a large amount of traffic requests within a very short period of time (e.g., one second), if the server counts a new set of traffic distribution probabilities once receiving a traffic request, it will take a longer time for recommending and there will be a high processing requirement for the server. Since there is usually no big difference when distributing the received traffic requests for the recommendation algorithms in a very short period of time, after the traffic distribution probabilities have been calculated, the calculated traffic distribution probabilities may be used to distribute traffic requests for the recommendation algorithms within a continuous predetermined time period. The predetermined time period is a time period between the statistical end moment for this time and the statistical end moment for the next time. The predetermined time period may be determined according to actual situations, for example, may be one minute, five minutes or one hour, etc.

In other words, after completion of this statistics, the server may distribute traffic requests for the recommendation algorithms according to the counted traffic distribution probabilities of the recommendation algorithms, until new traffic distribution probabilities of the recommendation algorithms are obtained after completion of the next statistics. At this point, the original traffic distribution probabilities of the recommendation algorithms are discarded, and the new traffic distribution probabilities of the recommendation algorithms are used to distribute traffic requests for the recommendation algorithms.

In sum, the recommendation algorithm optimization method according to one example of the present disclosure solves the problems of manually allocating traffic for recommendation algorithms and long optimization period during the process of optimization in the prior art, by obtaining statistical effectiveness data of each recommendation algorithm, calculating traffic distribution probability of each recommendation algorithm according to the effectiveness data of each recommendation algorithm, and distributing traffic requests for each recommendation algorithm according to the traffic distribution probability. Herein, the effectiveness data of the recommendation algorithm reflects a recommendation success rate of the recommendation algorithm. Since traffic may be automatically allocated to each recommendation algorithm according to the statistical recommendation success rate of each recommendation algorithm, more traffic may be allocated to recommendation algorithms with high recommendation success rates in a better manner, thereby greatly shortening the optimization period and improving efficiency and accuracy of optimization.

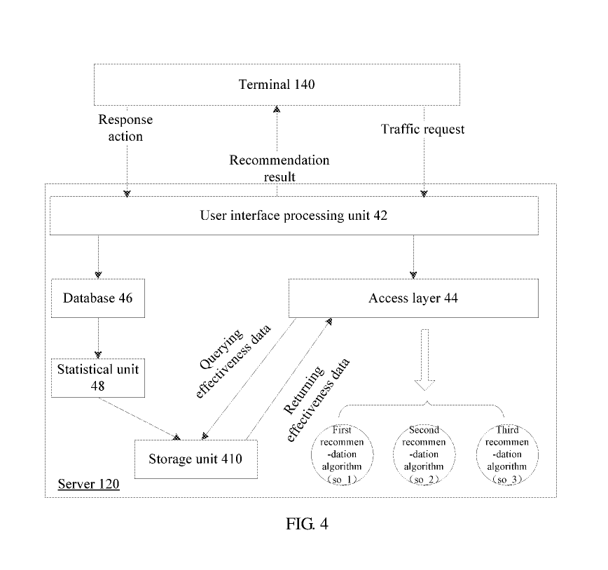

In one possible implementation, referring to FIG. 4, FIG. 4 is a schematic diagram illustrating internal structure of a server involved in some examples of the present disclosure. The server 120 may include but not limited to a user interface processing unit 42, an access layer 44, a database 46, a statistical unit 48 and a storage unit 410. The user interface processing unit 42 obtains various kinds of information such as traffic requests or response action sent from the terminal 140. The access layer 44 calls a recommendation algorithm so_1, a recommendation algorithm so_2 and a recommendation algorithm so_3 to process traffic requests. When implemented, there may be other recommendation algorithms, and this is a schematic example. The database 46 stores information of response actions obtained from the terminal 140. The statistical unit 48 counts the effectiveness data of each recommendation algorithm according to the response actions in the database 46. Generally, the statistical unit 48 can count in real time response action data in the database 46, for example, counting in real time effectiveness data of each recommendation algorithm in a one-hour sliding window, a three-hour sliding window, a five-hour sliding window, a fixed widow of one natural day or a fixed widow of seven natural days. The storage unit 410 stores the effectiveness data of each recommendation algorithm counted by the statistical unit 48.

In actual implementations, the user interface processing unit 42 receives a traffic request sent from the terminal 140, and sends the traffic request to the access layer 44. After receiving the traffic request, the access layer 44 sends a request for querying effectiveness data of each recommendation algorithm to the storage unit 410. The storage unit 410 returns the effectiveness data of each recommendation algorithm to the access layer 44. The access layer 44 calculates the traffic distribution probability of each recommendation algorithm, according to the effectiveness data of each recommendation algorithm obtained from the storage unit 410. The access layer 44 allocates a recommendation algorithm to the traffic request according to the traffic distribution probability of each recommendation algorithm obtained via calculation. After calculating the traffic distribution probability of each recommendation algorithm, the access layer 44 may continuously use the calculated traffic distribution probability of each recommendation algorithm to allocate recommendation algorithms to traffic requests within a specified time period. The specified time period may be set to be one minute; at the end of one minute, the traffic distribution probability of each recommendation algorithm stored in the access layer 44 is deleted. In this way, when receiving a next traffic request, the access layer 44 continues to send a request for querying effectiveness data of each recommendation algorithm to the storage unit 410.

Generally speaking, the specified time period is set to avoid the following situation. The access layer needs to obtain the effectiveness data of each recommendation algorithm from the storage unit 410 every time a traffic request is received, and calculates the traffic distribution probability of each recommendation algorithm, according to the obtained effectiveness data of each recommendation algorithm. The effectiveness data of each recommendation algorithm repeatedly obtained from the storage unit 410 in a short time period may be the same or similar, and have no obvious improvement to optimize distribution of the recommendation algorithms, but it will consume much computing performance of the server to frequently obtain effectiveness data from the storage unit 410 and calculate the traffic distribution probabilities.

Apparently, the statistical unit 48 may directly calculate the traffic distribution probability of each recommendation algorithm, according to the statistical effectiveness data of each recommendation algorithm, and store the traffic distribution probability of each recommendation algorithm in the storage unit 410. At this point, the access layer 44 may directly send a request for querying the traffic distribution probability of each recommendation algorithm to the storage unit 410. The storage unit 410 returns the traffic distribution probability of each recommendation algorithm to the access layer 44. The statistical unit 48 may perform one statistical operation, every time one response action is received from the terminal 140 or every a predetermined time interval. The statistical unit 48 may store the traffic distribution probability of each recommendation algorithm counted at each time in the storage unit 410. Accordingly, the storage unit 410 may use the last obtained traffic distribution probability of each recommendation algorithm to replace the original traffic distribution probability of each recommendation algorithm. Alternatively, the storage unit 410 may store the traffic distribution probability of each recommendation algorithm obtained at each time according to statistical moments. But in this case, when the access layer 44 sends a request for querying the traffic distribution probability of each recommendation algorithm to the storage unit 410, the storage unit 410 may return the effectiveness data of each recommendation algorithm corresponding to the last statistical moment to the access layer 44.

The access layer 44 may query the effectiveness data or traffic distribution probability of each recommendation algorithm in the storage unit 410 in a manually triggered mode.

It is noted that, the server 120 may be a stand-alone server or a combination of a plurality of servers. Thus, when the server 120 is a stand-alone server, herein, the access layer 44, the database 46, the statistical unit 48 and the storage unit 410 are components of the server. When the server 120 is a combination of a plurality of servers, herein, the access layer 44, the database 46, the statistical unit 48 and the storage unit 410 may be in different servers.

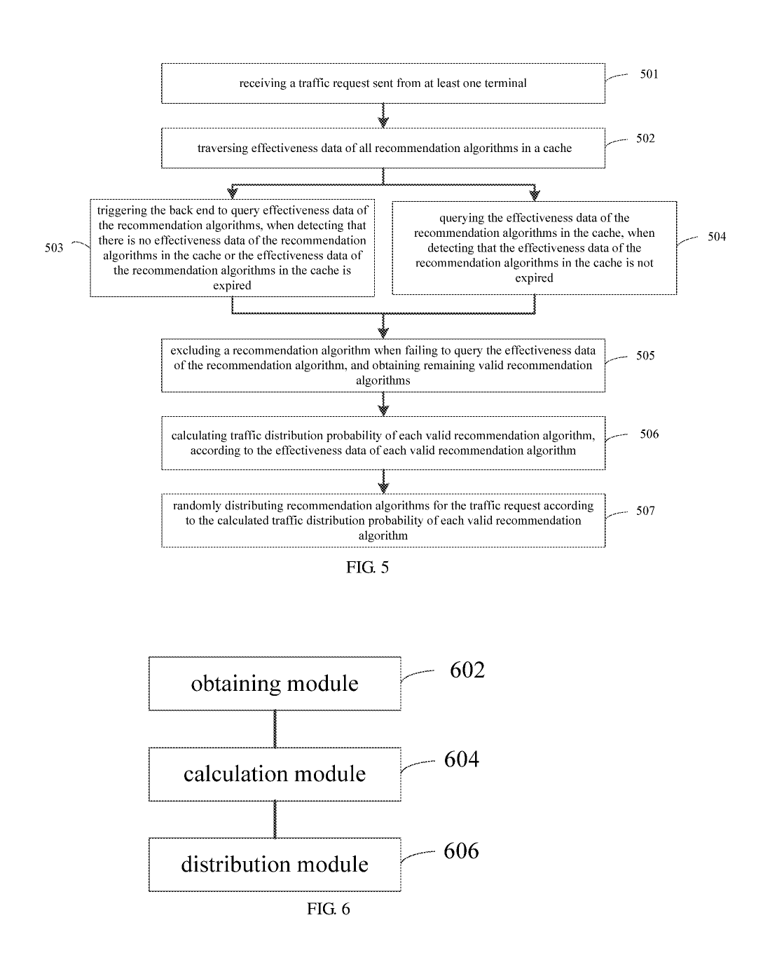

In another possible implementation, referring to FIG. 5, FIG. 5 is a flow chart of a process of distributing recommendation algorithms for requests according to one example of the present disclosure. One device which can implement the process of distributing recommendation algorithms for traffic requests may be in the access layer 44 of the server shown in FIG. 4. The process of distributing recommendation algorithms for traffic requests may include following blocks.

In block 501, receive a traffic request sent by at least one terminal.

For example, the traffic request sent by at least one terminal may be firstly received through the user interface processing unit 42; the user interface processing unit 42 sends the received traffic request to the access layer 44. Thus, the access layer 44 can synchronously receive the traffic request sent by at least one terminal.

In block 502, traverse effectiveness data of all recommendation algorithms in a cache.

The access layer 44 can traverse effectiveness data of all recommendation algorithms in a local cache.

In block 503, trigger the back end to query effectiveness data of the recommendation algorithms, when detecting that there is no effectiveness data of the recommendation algorithms in the cache or the effectiveness data of the recommendation algorithms in the cache is expired.

When the access layer 44 detects that there is no effectiveness data of the recommendation algorithms in the local cache, or the effectiveness data of the recommendation algorithms in the local cache is expired, the access layer 44 triggers the storage unit 410 at the back end to query effectiveness data of the recommendation algorithms.

In block 504, query the effectiveness data of the recommendation algorithms in the cache, when detecting that the effectiveness data of the recommendation algorithms in the cache is not expired.

When the access layer 44 detects that the effectiveness data of the recommendation algorithms in the cache is not expired, the access layer 44 can query the effectiveness data of the recommendation algorithms in the local cache.

In block 505, exclude a recommendation algorithm when failing to query the effectiveness data of the recommendation algorithm, and obtain remaining valid recommendation algorithms.

In block 506, calculate traffic distribution probability of each valid recommendation algorithm, according to the effectiveness data of each valid recommendation algorithm.

In block 507, request to randomly distribute recommendation algorithms for the traffic request according to the calculated traffic distribution probability of each valid recommendation algorithm.

As can be seen from the above, the effectiveness data of the recommendation algorithm reflects a recommendation success rate of the recommendation algorithm, and since traffic may be automatically allocated to each recommendation algorithm according to the statistical recommendation success rate of each recommendation algorithm, more traffic may be allocated to recommendation algorithms with high recommendation success rates in a better manner, thereby greatly shortening the optimization period, automatically optimizing distribution of traffic and improving efficiency and accuracy of optimization. Meanwhile, since the effectiveness data or traffic distribution probability of each recommendation algorithm can be cached in the local cache in the access layer, the recommendation algorithm optimization method can avoid such a situation where the recommendation effect of some recommendation algorithms sharply declines in certain conditions, and can automatically allocate the traffic to recommendation algorithms with good recommendation effect.

In another possible implementation, the effectiveness data of a recommendation algorithm within a certain time period may also be a total number of response actions within the certain time period. For one recommendation algorithm, a product of effectiveness data corresponding to each time period and a weight set for the each time period is obtained, and a sum of the products corresponding to all the time periods is obtained, and then the sum is taken as the total effectiveness data of the recommendation algorithm. The weight or traffic distribution probability of each recommendation algorithm is determined, according to the total effectiveness data of each recommendation algorithm.

For example, there exist recommendation algorithms including a first recommendation algorithm, a second recommendation algorithm and a third recommendation algorithm, the statistical time periods are respectively determined as a first time period, a second time period and a third time period, and weights assigned to the time periods are w1, w2 and w3, respectively.

For the first recommendation algorithm, a total number of response actions corresponding to the first recommendation algorithm in the first statistical time period is N11; a total number of response actions corresponding to the first recommendation algorithm in the second statistical time period is N12; a total number of response actions corresponding to the first recommendation algorithm in the third statistical time period is N13; then, the obtained total effectiveness data of the first recommendation algorithm is: F1=w1*N11+w2*N12+w3*N13.

For the second recommendation algorithm, a total number of response actions corresponding to the second recommendation algorithm in the first statistical time period is N21; a total number of response actions corresponding to the second recommendation algorithm in the second statistical time period is N22; a total number of response actions corresponding to the second recommendation algorithm in the third statistical time period is N23; then, the obtained total effectiveness data of the second recommendation algorithm is: F2=w1*N21+w2*N22+w3*N23.

For the third recommendation algorithm, a total number of response actions corresponding to the third recommendation algorithm in the first statistical time period is N31;a total number of response actions corresponding to the third recommendation algorithm in the second statistical time period is N32; a total number of response actions corresponding to the third recommendation algorithm in the third statistical time period is N33; then, the obtained total effectiveness data of the third recommendation algorithm is: F3=w1*N31+w2*N32+w3*N33.

In this way, the final weight or traffic distribution probability of the first recommendation algorithm is: F1/(F1+F2+F3); the final weight or traffic distribution probability of the second recommendation algorithm is: F2/(F1+F2+F3); the final weight or traffic distribution probability of the third recommendation algorithm is: F3/(F1+F2+F3).

The examples of the device will be described hereinafter, of which descriptions are not provided in detail and may refer to the above examples of the method.

Referring to FIG. 6, FIG. 6 is a schematic diagram illustrating structure of a recommendation algorithm optimization device according to an example of the present disclosure. The recommendation algorithm optimization device is illustrated with an example, where the recommendation algorithm optimization device is applied in the server 120 of the implementation environment shown in FIG. 1. The recommendation algorithm optimization device may include an obtaining module 602, a calculation module 604 and a distribution module 606.

The obtaining module 602 obtains statistical effectiveness data of each recommendation algorithm. The effectiveness data is to reflect a recommendation success rate of each recommendation algorithm within an identical statistical time window.

The calculation module 604 obtains traffic distribution probability of each recommendation algorithm, according to weight of the effectiveness data of each recommendation algorithm obtained by the obtaining module 602 in the effectiveness data of recommendation algorithms.

The distribution module 606 distributes traffic requests for each recommendation algorithm, according to the traffic distribution probability obtained by the calculation module 604 through calculating.

In sum, the recommendation algorithm optimization device according to one example of the present disclosure solves the problems of manually allocating traffic for recommendation algorithms and long optimization period during the process of optimization in the prior art, by obtaining statistical effectiveness data of each recommendation algorithm, calculating traffic distribution probability of each recommendation algorithm according to the effectiveness data of each recommendation algorithm, and distributing traffic request for each recommendation algorithm according to the traffic distribution probability. Herein, the effectiveness data of the recommendation algorithm reflects a recommendation success rate of the recommendation algorithm. Since traffic may be automatically allocated to each recommendation algorithm according to the statistical recommendation success rate of each recommendation algorithm, more traffic may be allocated to recommendation algorithms with high recommendation success rates in a better manner, thereby greatly shortening the optimization period and improving efficiency and accuracy of optimization.

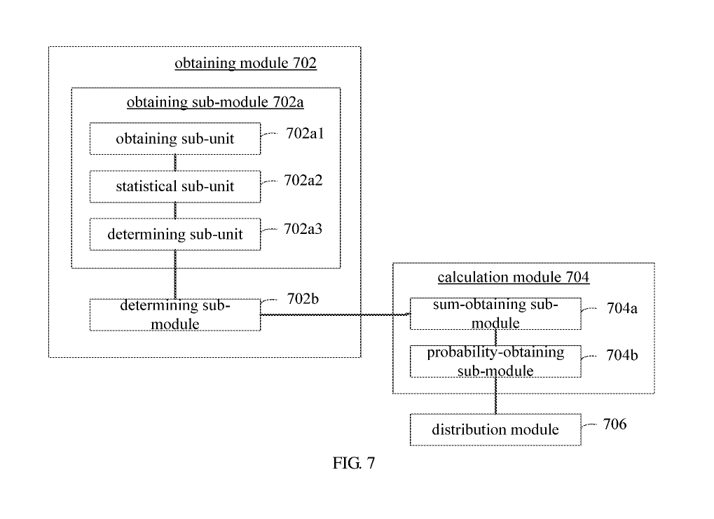

Referring to FIG. 7, FIG. 7 is a schematic diagram illustrating structure of a recommendation algorithm optimization device according to one example of the present disclosure. The recommendation algorithm optimization device is illustrated with an example, where the recommendation algorithm optimization device is applied in the server 120 of the implementation environment shown in FIG. 1. The recommendation algorithm optimization device may include an obtaining module 702, a calculation module 704 and a distribution module 706.

The obtaining module 702 obtains statistical effectiveness data of each recommendation algorithm. The effectiveness data is to reflect a recommendation success rate of each recommendation algorithm within an identical statistical time window.

The calculation module 704 obtains traffic distribution probability of each recommendation algorithm, according to weight of the effectiveness data of each recommendation algorithm obtained by the obtaining module 702 in the effectiveness data of recommendation algorithms.

The distribution module 706 distributes traffic requests for each recommendation algorithm, according to the traffic distribution probability obtained by the calculation module 704 through calculating.

In a first possible implementation of the example, the obtaining module 702 may include an obtaining sub-module 702a and a determining sub-module 702b.

The obtaining sub-module 702a obtains recommendation success rates of each recommendation algorithm corresponding to at least two overlapping time periods which belong to the statistical time window. The overlapping time periods have an identical statistical end moment and different statistical start moments.

The determining sub-module 702b obtains a product of a recommendation success rate corresponding to each of the overlapping time periods and a weight corresponding to each of the overlapping time periods, obtains a sum of the products, and takes the sum as the effectiveness data of the recommendation algorithm in the statistical time window.

In a second possible implementation of the example, the obtaining sub-module 702a may include an obtaining sub-unit 702a1, a statistical sub-unit 702a2 and a determining sub-unit 702a3.

The obtaining sub-unit 702a1 obtains a corresponding response action and a recommendation result of a recommendation algorithm within each time period. The response action is a successful response from at least one terminal within a time period to the recommendation result, which is determined according to the recommendation algorithm. The recommendation result is determined according to the recommendation algorithm within a time period.

The statistical sub-unit 702a2 counts the number of the response actions and the number of the recommendation results.

The determining sub-unit 702a3 obtains a quotient value after dividing the number of the response actions counted at the statistical sub-unit 702a2 by the number of the recommendation results counted at the statistical sub-unit 702a2, and takes the quotient value as a recommendation success rate of the recommendation algorithm within the time period.

In a third possible implementation of the example, the calculation module 704 may include a sum-obtaining sub-module 704a and a probability-obtaining sub-module 704b.

The sum-obtaining sub-module 704a obtains a sum of the effectiveness data of each recommendation algorithm.

The probability-obtaining sub-module 704b obtains a traffic distribution probability of each recommendation algorithm, after dividing the effectiveness data of each recommendation algorithm by the sum of the effectiveness data of the recommendation algorithms.

In a fourth possible implementation of the example, the distribution module 706 is further to distribute traffic requests for each recommendation algorithm within a predetermined time period according to the traffic distribution probability. The predetermined time period is a time period between the statistical end moment for this time and the statistical end moment for the next time.

In sum, the recommendation algorithm optimization device according to one example of the present disclosure solves the problems of manually allocating traffic for recommendation algorithms and long optimization period during the process of optimization in the prior art, by obtaining statistical effectiveness data of each recommendation algorithm, calculating traffic distribution probability of each recommendation algorithm according to the effectiveness data of each recommendation algorithm, and distributing traffic request for each recommendation algorithm according to the traffic distribution probability. Herein, the effectiveness data of the recommendation algorithm reflects a recommendation success rate of the recommendation algorithm. Since traffic may be automatically allocated to each recommendation algorithm according to the statistical recommendation success rate of each recommendation algorithm, more traffic may be allocated to recommendation algorithms with high recommendation success rates in a better manner, thereby greatly shortening the optimization period and improving efficiency and accuracy of optimization.

It is noted that, the process that the recommendation algorithm optimization device of the above example optimizes recommendation algorithms is illustrated with an example of the above divided function modules. When implemented, the above functions may be assigned to and completed by different function modules according to needs, that is, internal structure of the server may be divided into different functional modules, so as to complete some or all of the above described functions. In addition, the recommendation algorithm optimization device of the above example belongs to the same concept as the recommendation algorithm optimization method of the above example, and the specific implementation process of the recommendation algorithm optimization device refers to the method example and will not be repeated herein.

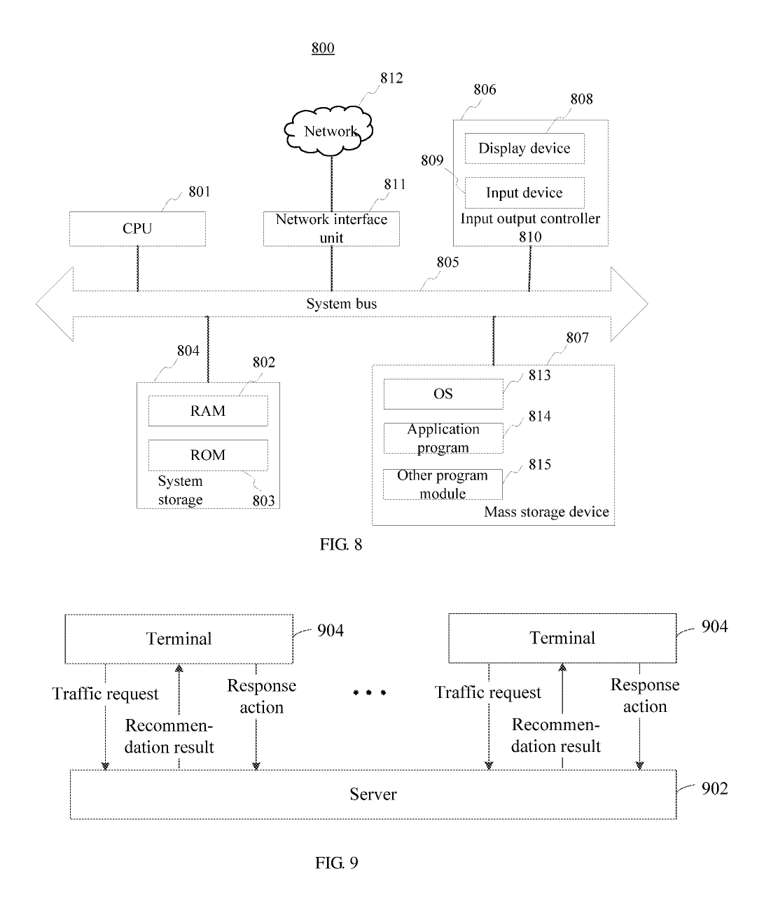

Referring to FIG. 8, FIG. 8 is a schematic block diagram illustrating structure of a server according to some examples of the present disclosure. The server 800 may implement the above recommendation algorithm optimization method of the above example. The server 800 includes a central processing unit (CPU) 801, a system storage 804 including a random access memory (RAM) 802 and a read-only memory (ROM) 803, a system bus 805 which is connected with the system storage 804 and the CPU 801. The server 800 further includes a basic input output system (I/O system) 806 which helps to transfer information among components of a computer, and a mass storage device 807 for storing an operating system (OS) 813, application programs 814 and other program modules 815.

The basic I/O system 806 includes a display device 808 for displaying information and an input device 809 such as a mouse, a keyboard, for a user to input information. The display device 808 and the input device 809 are connected to the CPU 801 through an input output controller 810 which is connected to the system bus 805. The basic I/O system 806 may further include the input output controller 810 for receiving and processing information input from the keyboard, the mouse or other input device such as an electronic stylus. Similarly, the input output controller 810 may provide information output to the display device, a printer or other output device.

The mass storage device 807 is connected to the CPU 801 via a mass storage controller (not shown) which is connected to the system bus 805. The mass storage device 807 together with associated computer-readable medium may provide non-transitory storage for the server 800. That is, the mass storage device 807 may include computer-readable medium (not shown) such as a hard disk or compact disk-ROM (CD-ROM) drive.

Generally, the computer-readable medium may include computer storage medium and communication medium. The computer storage medium may include transitory or non-transitory, removable or non-removable media of any method or technology, for storing information such as computer-readable instructions, data structure, program module or other data. The computer storage medium may include RAM, ROM, erasable programmable read-only memory (EPROM), electrically erasable programmable read-only memory (EEPROM), flash memory or other solid state memory, CD-ROM, digital video disc (DVD), or other optical storage, magnetic cassettes, magnetic tape, magnetic disk storage or other magnetic storage devices. Certainly, a person skilled in the art would understand that the computer storage medium is not limited to the above. The above system storage 804 and the mass storage device 807 may be collectively referred to as memory.

According to various examples of the present disclosure, the server 800 may be connected with a remote computer running on the network through the network connection such as the Internet. That is, the server 800 may be connected to the network 812 through a network interface unit 811, which is connected with the system bus 805. In other words, the network interface unit 811 enables the server 800 to connect with other types of networks or remote computer systems (not shown).

The memory further includes one or more programs. The one or more programs are stored in the memory and to be executed by one or more CPUs 801. The one or more CPUs 801 are to perform following blocks:

obtaining statistical effectiveness data of each recommendation algorithm, where the effectiveness data is to reflect a recommendation success rate of each recommendation algorithm within an identical statistical time window;

obtaining traffic distribution probability of each recommendation algorithm, according to weight of the effectiveness data of each recommendation algorithm in the effectiveness data of recommendation algorithms;

distributing traffic requests for each recommendation algorithm according to the traffic distribution probability.

In a first possible implementation of the example, obtaining statistical effectiveness data of each recommendation algorithm includes:

obtaining recommendation success rates of each recommendation algorithm corresponding to at least two overlapping time periods which belong to the statistical time window, where the overlapping time periods have an identical statistical end moment and different statistical start moments;

obtaining a product of the recommendation success rate corresponding to each of the overlapping time periods and a weight corresponding to each of the overlapping time periods, obtaining a sum of the products, and taking the sum as the effectiveness data of the recommendation algorithm in the statistical time window.

In a second possible implementation of the example, obtaining recommendation success rates of each recommendation algorithm corresponding to at least two overlapping time periods which belong to the statistical time window includes:

obtaining a corresponding response action and a recommendation result of each recommendation algorithm within each time period, where the response action is a successful response from at least one terminal within each time period to the recommendation result, which is determined according to the recommendation algorithm, and the recommendation result is determined according to the recommendation algorithm within each time period;

counting the number of the response actions and the number of the recommendation results;

obtaining a quotient value after dividing the number of the response actions by the number of the recommendation results, and taking the quotient value as a recommendation success rate of the recommendation algorithm within the time period.

In a third possible implementation of the example, obtaining traffic distribution probability of each recommendation algorithm according to weight of the effectiveness data of each recommendation algorithm in the effectiveness data of recommendation algorithms includes:

obtaining a sum of the effectiveness data of the recommendation algorithms;

obtaining a traffic distribution probability of each recommendation algorithm after dividing the effectiveness data of each recommendation algorithm by the sum of the effectiveness data of the recommendation algorithms.

In a fourth possible implementation of the example, distributing traffic requests for each recommendation algorithm according to the traffic distribution probability includes:

distributing traffic requests for each recommendation algorithm within a predetermined time period according to the traffic distribution probability, in which the predetermined time period is a time period between the statistical end moment for this time and the statistical end moment for the next time.

Referring to FIG. 9, FIG. 9 is a schematic diagram of a recommendation algorithm optimization system according to one example of the present disclosure. The recommendation algorithm optimization system is illustrated with an example, in which the recommendation algorithm optimization system is applied in the implementation environment shown in FIG. 1. The recommendation algorithm optimization system may include a server 902 and at least one terminal 904. The server 902 may be connected to the terminal 904 through a wire network or a wireless network. The terminal 904 can transmit a traffic request to the server 902. The server 902 can return a recommendation result to the terminal 904. Correspondingly, the terminal 904 may choose to respond to the recommendation result.

The server 902 may include the recommendation algorithm optimization device shown in FIG. 6 or FIG. 7. Alternatively, the server 902 may be the server shown in FIG. 8.

In sum, the recommendation algorithm optimization system according to one example of the present disclosure solves the problems of manually allocating traffic for recommendation algorithms and long optimization period during the process of optimization in the prior art, by obtaining at the server statistical effectiveness data of each recommendation algorithm, calculating traffic distribution probability of each recommendation algorithm according to the effectiveness data of each recommendation algorithm, and distributing traffic request for each recommendation algorithm according to the traffic distribution probability. Herein, the effectiveness data of the recommendation algorithm reflects a recommendation success rate of the recommendation algorithm. Since traffic may be automatically allocated to each recommendation algorithm according to the statistical recommendation success rate of each recommendation algorithm, more traffic may be allocated to recommendation algorithms with high recommendation success rates in a better manner, thereby greatly shortening the optimization period and improving efficiency and accuracy of optimization.

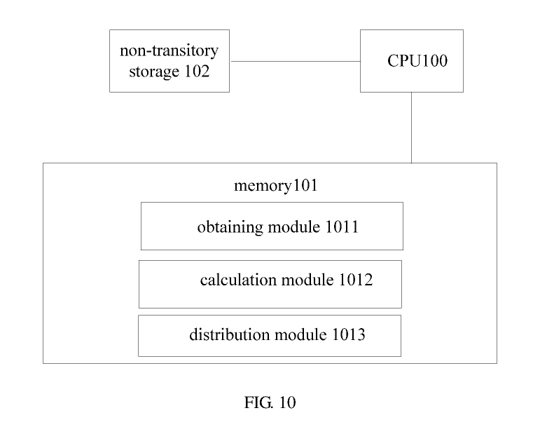

FIG. 10 is a schematic diagram illustrating structure of a recommendation algorithm optimization device according to another example of the present disclosure. As shown in FIG. 10, the video playing device may include a CPU 100, a memory 101 and a non-transitory storage 102.

The non-transitory storage 102 stores computer programs for implementing recommendation algorithm optimization.

The CPU 100 loads the computer programs in the non-transitory storage 102 into the memory 101 and runs the computer programs to form computer-executable instructions, and the computer-executable instructions are stored in an obtaining module 1011, a calculation module 1012 and a distribution module 1013.

The obtaining module 1011 obtains statistical effectiveness data of each recommendation algorithm, and the effectiveness data is to reflect a recommendation success rate of each recommendation algorithm within an identical statistical time window.

The calculation module 1012 obtains traffic distribution probability of each recommendation algorithm, according to weight of the effectiveness data of each recommendation algorithm obtained by the obtaining module 1011 in the effectiveness data of recommendation algorithms.

The distribution module 1013 distributes traffic requests for each recommendation algorithm, according to the traffic distribution probability obtained by the calculation module 1012 through calculating.

In one implementation, functions of the obtaining module 1011, the calculation module 1012 and the distribution module 1013 are the same as those of the obtaining module 702, the calculation module 704 and the distribution module 706 in the recommendation algorithm optimization device shown in FIG. 7, and will not be repeated herein.

Sequence number in above examples of the present disclosure is only used for descriptions, which doesn't demonstrate good or better example.

One of ordinary skill in the art would understand that all or some of the above examples may be implemented with hardware, or with hardware instructed by a program. The program may be stored in a computer readable medium, which may be a ROM, magnetic disk or CD, and so on.

The foregoing are only preferred examples of the present disclosure, and are not used to limit the present invention. Any modification, equivalent replacement, or improvement made without departing from the spirit and principle of the present disclosure should fall within the scope of the present disclosure.

1. A recommendation algorithm optimization method, comprising:
obtaining statistical effectiveness data of each recommendation algorithm, wherein the effectiveness data is to reflect a recommendation success rate of each recommendation algorithm within an identical statistical time window;
obtaining a traffic distribution probability of each recommendation algorithm, according to weight of the effectiveness data of each recommendation algorithm in the effectiveness data of recommendation algorithms; and,
distributing traffic requests for each recommendation algorithm according to the traffic distribution probability.

2. The method of claim 1, wherein obtaining the statistical effectiveness data of each recommendation algorithm comprises:
obtaining recommendation success rates of each recommendation algorithm corresponding to at least two overlapping time periods which belong to the statistical time window, wherein the overlapping time periods have an identical statistical end moment and different statistical start moments;
obtaining a product of the recommendation success rate corresponding to each of the overlapping time periods and a weight corresponding to each of the overlapping time periods, obtaining a sum of the products, and taking the sum as the effectiveness data of the recommendation algorithm in the statistical time window.

3. The method of claim 2, wherein obtaining the recommendation success rates of each recommendation algorithm corresponding to at least two overlapping time periods which belong to the statistical time window comprises:
obtaining a corresponding response action and a recommendation result of each recommendation algorithm within each time period, wherein the response action is a successful response from at least one terminal within each time period to the recommendation result, which is determined according to the recommendation algorithm, and the recommendation result is determined according to the recommendation algorithm within each time period;
counting the number of the response actions and the number of the recommendation results;
obtaining a quotient value after dividing the number of the response actions by the number of the recommendation results, and taking the quotient value as the recommendation success rate of each recommendation algorithm within the time period.

4. The method of claim 2, wherein obtaining the traffic distribution probability of each recommendation algorithm according to the weight of the effectiveness data of each recommendation algorithm in the effectiveness data of recommendation algorithms comprises:
obtaining a sum of the effectiveness data of all the recommendation algorithms;
obtaining the traffic distribution probability of each recommendation algorithm, after dividing the effectiveness data of each recommendation algorithm by the sum of the effectiveness data of all the recommendation algorithms.

5. The method of claim 4, wherein distributing the traffic requests for each recommendation algorithm according to the traffic distribution probability comprises:
distributing the traffic requests for each recommendation algorithm within a predetermined time period according to the traffic distribution probability, wherein the predetermined time period is a time period between a statistical end moment for this time and a statistical end moment for the next time.

6. A recommendation algorithm optimization device, comprising an obtaining module, a calculation module and a distribution module, wherein
the obtaining module obtains statistical effectiveness data of each recommendation algorithm, wherein the effectiveness data is to reflect a recommendation success rate of each recommendation algorithm within an identical statistical time window;
the calculation module obtains a traffic distribution probability of each recommendation algorithm, according to weight of the effectiveness data of each recommendation algorithm obtained by the obtaining module in the effectiveness data of recommendation algorithms; and
the distribution module distributes traffic requests for each recommendation algorithm, according to the traffic distribution probability obtained by the calculation module through calculating.

7. The device of claim 6, wherein the obtaining module comprises an obtaining sub-module and a determining sub-module,
the obtaining sub-module obtains recommendation success rates of each recommendation algorithm corresponding to at least two overlapping time periods which belong to the statistical time window, wherein the overlapping time periods have an identical statistical end moment and different statistical start moments;
the determining sub-module obtains a product of the recommendation success rate corresponding to each of the overlapping time periods and a weight corresponding to each of the overlapping time periods, obtains a sum of the products, and takes the sum as the effectiveness data of the recommendation algorithm in the statistical time window.

8. The device of claim 7, wherein the obtaining sub-module comprises an obtaining sub-unit, a statistical sub-unit and a determining sub-unit,
the obtaining sub-unit obtains a corresponding response action and a recommendation result of each recommendation algorithm within each time period, wherein the response action is a successful response from at least one terminal within each time period to the recommendation result determined according to the recommendation algorithm, and the recommendation result is determined according to the recommendation algorithm within each time period;
the statistical sub-unit counts the number of the response actions and the number of the recommendation results;
the determining sub-unit obtains a quotient value after dividing the number of the response actions counted at the statistical sub-unit by the number of the recommendation results counted at the statistical sub-unit, and takes the quotient value as the recommendation success rate of each recommendation algorithm within the time period.

9. The device of claim 7, wherein the calculation module comprises a sum-obtaining sub-module, and a probability-obtaining sub-module,
the sum-obtaining sub-module obtains a sum of the effectiveness data of all the recommendation algorithms; and,
the probability-obtaining sub-module obtains the traffic distribution probability of each recommendation algorithm, after dividing the effectiveness data of each recommendation algorithm by the sum of the effectiveness data of all the recommendation algorithms.

10. The device of claim 9, wherein the distribution module further distributes traffic requests for each recommendation algorithm within a predetermined time period according to the traffic distribution probability; the predetermined time period is a time period between a statistical end moment for this time and a statistical end moment for the next time.

11. A recommendation algorithm optimization device, comprising: a processor, a memory and a non-transitory storage;
wherein the non-transitory storage stores computer programs for implementing recommendation algorithm optimization;
the processor loads the computer programs from the non-transitory storage into the memory, and runs the computer programs to form computer-executable instructions, and the computer-executable instructions are stored in an obtaining module, a calculation module and a distribution module;
the obtaining module obtains statistical effectiveness data of each recommendation algorithm, and the effectiveness data is to reflect a recommendation success rate of each recommendation algorithm within an identical statistical time window;
the calculation module obtains a traffic distribution probability of each recommendation algorithm, according to weight of the effectiveness data of each recommendation algorithm obtained by the obtaining module in the effectiveness data of recommendation algorithms; and
the distribution module distributes traffic requests for each recommendation algorithm according to the traffic distribution probability obtained by the calculation module through calculating.

12. The device of claim 11, wherein the obtaining module comprises an obtaining sub-module and a determining sub-module,
the obtaining sub-module obtains recommendation success rates of each recommendation algorithm corresponding to at least two overlapping time periods which belong to the statistical time window, wherein the overlapping time periods have an identical statistical end moment and different statistical start moments;
the determining sub-module obtains a product of the recommendation success rate corresponding to each of the overlapping time periods and a weight corresponding to each of the overlapping time periods, obtains a sum of the products, and takes the sum as the effectiveness data of the recommendation algorithm in the statistical time window.

13. The device of claim 12, wherein the obtaining sub-module comprises an obtaining sub-unit, a statistical sub-unit and a determining sub-unit,
the obtaining sub-unit obtains a corresponding response action and a recommendation result of each recommendation algorithm within each time period, wherein the response action is a successful response from at least one terminal within each time period to the recommendation result determined according to the recommendation algorithm, and the recommendation result is determined according to the recommendation algorithm within each time period;
the statistical sub-unit counts the number of the response actions and the number of the recommendation results; and,
the determining sub-unit obtains a quotient value after dividing the number of the response actions counted at the statistical sub-unit by the number of the recommendation results counted at the statistical sub-unit, and takes the quotient value as the recommendation success rate of each recommendation algorithm within the time period.

14. The device of claim 12, wherein the calculation module comprises a sum-obtaining sub-module and a probability-obtaining sub-module,
the sum-obtaining sub-module obtains a sum of the effectiveness data of all the recommendation algorithms; and,
the probability-obtaining sub-module obtains the traffic distribution probability of each recommendation algorithm after dividing the effectiveness data of each recommendation algorithm by the sum of the effectiveness data of all the recommendation algorithms.

15. The device of claim 14, wherein the distribution module further distributes the traffic requests for each recommendation algorithm within a predetermined time period according to the traffic distribution probability; the predetermined time period is a time period between a statistical end moment for this time and a statistical end moment for the next time.

16. (canceled)
